(19) United States
(12) Patent Application Publication
(10) Pub. No.: US 2016/0378908 A1
(43) Pub. Date: Dec. 29, 2016

(54) ALGEBRAIC RECONSTRUCTION OF PERTURBED MODELS OF GENETIC POPULATIONS

(71) Applicant: International Business Machines Corporation, Armonk, NY (US)

(72) Inventors: Niina S. Haiminen, White Plains, NY (US); Laxmi P. Parida, Mohegan Lake, NY (US)

(21) Appl. No.: 14/963,994

(22) Filed: Dec. 9, 2015

Related U.S. Application Data
(63) Continuation of application No. 14/747,088, filed on Jun. 23, 2015.

(51) Int. Cl. G06F 19/12; G06F 17/16

(52) U.S. Cl. CPC G06F 19/12; G06F 17/16

(57) ABSTRACT

Embodiments are directed to a computer-based simulation system including an input circuit, a memory and a processor system communicatively coupled to the memory and the input circuit. The input circuit is configured to receive an input distribution. The processor system is configured to assign, for each marker of a simulated population matrix, a minor allele frequency. The processor system is further configured to assign, for each marker and each distance of the simulated population matrix, a linkage disequilibrium (LD).

The present application claims priority to U.S. Non-provisional application 14/747,088 filed on Jun. 23, 2015 titled “ALGEBRAIC RECONSTRUCTION OF PERTURBED MODELS OF GENETIC POPULATIONS,” assigned to the assignee hereof and expressly incorporated by reference herein.

### BACKGROUND

The present disclosure relates in general to the computer-aided generation of simulated genetic populations. More specifically, the present disclosure relates to systems and methodologies for simulating final models of genetic populations directly based on a given linkage disequilibrium (LD) distribution and without the need to use forward-simulation models and intermediate genetic populations.

It is known to use computer-based simulation tools to understand the evolutionary and genetic consequences of complex processes. Computer-based simulation tools often involve a range of components, including modules for preparation, extraction and conversion of data, program codes that perform experiment-related computations, and scripts that join the other components and make them work as a coherent system that is capable of displaying desired behavior. Although these tools have traditionally been used in population genetics by a fairly small community with programming expertise, the rapid increase in computer processing power in the past few decades has enabled the emergence of sophisticated, customizable software packages for performing experiments in silico (i.e., on a computer or via computer simulation), whereby research is conducted with computer simulated models that closely reflect the real world.

In many studies, it is important to work with an artificial population to evaluate the efficacy of different methods or simply generate a founder population for an in silico breeding regimen. The populations are usually specified by a set of characteristics such as minimum allele frequency (MAF) distribution and LD distribution. An allele is one of a number of alternative forms of the same gene or same genetic locus. Allele frequency, or gene frequency, is the proportion of a particular allele among all allele copies being considered. It can be formally defined as the percentage of all alleles at a given locus in a population gene pool represented by a particular allele. LD is the non-random association of alleles at different loci. In other words, LD is the presence of statistical associations between alleles at different loci that are different from what would be expected if alleles were independently, randomly sampled based on their individual allele frequencies. If there is no LD between alleles at different loci, they are said to be in linkage equilibrium. LD is influenced by many factors, including the rate of recombination, the rate of mutation, genetic drift, the system of mating, population structure and genetic linkage. As a result, the pattern of LD in a genome is a powerful signal of the population genetic forces that are structuring it. F_{ST} is a measure of population differentiation due to genetic structure. It is frequently estimated from genetic polymorphism data, such as single-nucleotide polymorphisms (SNP) or microsatellites. SNP is a DNA sequence variation occurring commonly within a population (e.g., 1%) in which a single nucleotide (e.g., A, T, C or G) in the genome differs between members of a biological species or paired chromosomes. For example, two sequenced DNA fragments from different individuals, AAGCCTA to AAGCTTA, contain a difference in a single nucleotide. Almost all common SNPs have only two alleles.

The problem of generating a simulated genetic population model may be stated as the problem of generating a population of “N” diploids (or “2N” haploids) with “M” bi-allelic SNPs given the following inputs: a MAF “p” distribution, and an average LD (“r²”) distribution per genetic distance. MAF refers to the frequency at which the least common allele occurs in a given population. The parameters “p” and “r²” are typically derived from an existing population “P”, and the task is to generate a “perturbed” population P′ that shows similar characteristics as “P.” Known generative models that are used to simulate the population P′ generally rely on forward-simulation models and intermediate genetic populations. Specifically, known generative simulation models require the estimation of the founder population, its size, the number of generations, mutation, recombination rates and a host of other parameters that would eventually generate a population satisfying the given (input) characteristics. The techniques to estimate these population evolution parameters are not well understood and usually involve simulation studies.

### SUMMARY

Embodiments are directed to a computer-based simulation system including an input circuit, a memory and a processor system communicatively coupled to the memory and the input circuit. The input circuit is configured to receive an input distribution. The processor system is configured to assign, for each marker of a simulated population matrix, a minor allele frequency. The processor system is further configured to assign, for each marker and each distance of the simulated population matrix, a LD. The processor system is further configured to assign, for each individual in the simulated population, at each marker, a value (1 or 0) indicating if that individual has the least frequent allele or the most frequent allele at that locus.

Embodiments are further directed to a computer-based simulation method that includes receiving, using an input circuit, an input distribution. The method further includes using a processor system to assign a minor allele frequency for each marker of a simulated population matrix. The method further includes using the processor system to assign a LD for each marker and each distance of the simulated population matrix. The method further includes using the processor system to assign, for each individual in the simulated population, at each marker, a value (1 or 0) indicating if that individual has the least frequent allele or the most frequent allele at that locus.

Embodiments are further directed to a computer program product for implementing a computer based simulation method. The computer program product includes a computer readable storage medium having program instructions embodied therewith, wherein the computer readable storage medium is not a transitory signal per se. The program instructions are readable by at least one processor circuit to cause the at least one processor circuit to perform a method. The method includes receiving, using an input circuit, an input distribution. The method further includes using a processor system to assign a minor allele frequency for each marker of a simulated population matrix. The method further includes using the processor system to assign a linkage disequilibrium LD for each marker and each distance of the simulated population matrix. The method further includes using the processor system to assign, for each individual in the simulated population, at each marker, a value (1 or 0) indicating if that individual has the least frequent allele or the most frequent allele at that locus.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as the present disclosure is particularly pointed out and distinctly claimed in the claims at the conclusion of the specification. The foregoing and other features and advantages are apparent from the following detailed description taken in conjunction with the accompanying drawings in which:

FIG. 1 depicts a diagram illustrating a distribution used as inputs characteristics according to one or more embodiments;

FIG. 2 depicts an output matrix illustrating an example of a genetic population that satisfies the input characteristics of the distribution shown in FIG. 1;

FIG. 3 depicts an exemplary computer system capable of implementing one or more embodiments of the present disclosure;

FIG. 4 depicts a diagram illustrating a genetic population modeling system according to one or more embodiments;

FIG. 5 depicts a flow diagram illustrating an overall methodology according to one or more embodiments;

FIG. 6 depicts a diagram illustrating the limits on LD (i.e., r²) imposed by assigning the MAFs according to the system shown in FIG. 4 and the methodology shown in FIG. 5;

FIG. 7 depicts a perturbation calculation for determining a distance (D) according to one or more embodiments;

FIG. 8 illustrates an Algorithm 1 that may be applied to assign LD constraints according to one or more embodiments;

FIG. 9 depicts a combination of combinatoric solution methods and linear algebra solution methods, which may be used in developing an algebraic combinatorial algorithm to generate a population according to one or more embodiments;

FIG. 10 depicts the linear algebraic equations of FIG. 9 in a format that facilitates the use a standard solver for integer programming (IP) according to one or more embodiments;

FIG. 11 depicts a more explicit expression of the linear algebraic equations of FIG. 10 according to one or more embodiments;

FIG. 12 depicts an Algorithm 2 that may be applied to generate a population with MAF constraints and LD constraints according to one or more embodiments; and

FIG. 13 depicts a computer program product in accordance with one or more embodiments.

In the accompanying figures and following detailed description of the disclosed embodiments, the various elements illustrated in the figures are provided with three or four digit reference numbers. The leftmost digit(s) of each reference number corresponds to the figure in which its element is first illustrated.

### DETAILED DESCRIPTION

Various embodiments of the present disclosure will now be described with reference to the related drawings. Alternate embodiments may be devised without departing from the scope of this disclosure. It is noted that various connections are set forth between elements in the following description and in the drawings. These connections, unless specified otherwise, may be direct or indirect, and the present disclosure is not intended to be limiting in this respect. Accordingly, a coupling of entities may refer to either a direct or an indirect connection.

Computational biology is the science of using biological data to develop algorithms and relations among various biological systems in order to quickly analyze and interpret relevant information. The field is broadly defined and includes foundations in computer science, applied mathematics, animation, statistics, biochemistry, chemistry, biophysics, molecular biology, genetics, genomics, ecology, evolution, anatomy, neuroscience and visualization.

As previously noted herein, it is known to use computer-based simulation tools to understand the evolutionary and genetic consequences of complex processes. Computer-based simulation tools often involve a range of components, including modules for preparation, extraction and conversion of data, program codes that perform experiment-related computations, and scripts that join the other components and make them work as a coherent system that is capable of displaying desired behavior. Although these tools have traditionally been used in population genetics by a fairly small community with programming expertise, the rapid increase in computer processing power in the past few decades has enabled the emergence of sophisticated, customizable software packages for performing experiments in silico (i.e., on a computer or via computer simulation), whereby research is conducted with computer simulated models that closely reflect the real world. This increased capability to produce genetic data in silico, along with the greater availability of population-genomics data, are transforming how research is conducted in many domains, including for example genetic epidemiology, anthropology, evolutionary and population genetics and conservation. In silico experimentation provides researchers with a number of benefits, including higher precision and better quality of experimental data, better support for data-intensive research, access to vast sets of experimental data generated by scientific communities, more accurate simulations through more sophisticated models, faster individual experiments and higher work productivity.

In many studies, it is important to work with an artificial population to evaluate the efficacy of different methods or simply generate a founder population for an in silico breeding regimen. The populations are usually specified by a set of characteristics such as MAF distribution and LD distribution. An allele is one of a number of alternative forms of the same gene or same genetic locus. Sometimes, different alleles can result in different observable phenotypic traits, such as different pigmentation. However, most genetic variations result in little or no observable variation. Allele frequency, or gene frequency, is the proportion of a particular allele among all allele copies being considered. It can be formally defined as the percentage of all alleles at a given locus in a population gene pool represented by a particular allele. In other words, it is the number of copies of a particular allele divided by the number of copies of all alleles at the genetic place (locus) in a population. Allele frequency is usually expressed as a percentage. Allele frequencies are used to depict the amount of genetic diversity at the individual, population, and species level. They are also the relative proportion of all alleles of a gene that are of a designated type. In population genetics, LD is the non-random association of alleles at different loci, i.e., the presence of statistical associations between alleles at different loci that are different from what would be expected if alleles were independently, randomly sampled based on their individual allele frequencies. If there is no LD between alleles at different loci, they are said to be in linkage equilibrium. LD is influenced by many factors, including the rate of recombination, the rate of mutation, genetic drift, the system of mating, population structure and genetic linkage. As a result, the pattern of LD in a genome is a powerful signal of the population genetic forces that are structuring it. LD may exist between alleles at different loci without any genetic linkage between them and independently of whether or not allele frequencies are in equilibrium (i.e., not changing with time).

The problem of generating simulated genetic population models may be stated as the problem of generating a population of “N” diploids (or “2N” haploids) with “M” bi-allelic SNPs given the following inputs: a MAFs “p” distribution, and an average LD (“r²”) distribution per genetic distance. MAF refers to the frequency at which the least common allele occurs in a given population. The parameters “p” and “r²” are typically derived from an existing population “P”, and the task is to generate a “perturbed” population P′ that shows similar characteristics as “P.” Known generative models that are used to simulate the population P′ generally rely on forward-simulation models and intermediate genetic populations. Specifically, known generative simulation models require the estimation of the founder population, its size, the number of generations, mutation, recombination rates and a host of other parameters that would eventually generate a population satisfying the given (input) characteristics. The techniques to estimate these population evolution parameters are not well-understood and usually involve simulation studies.

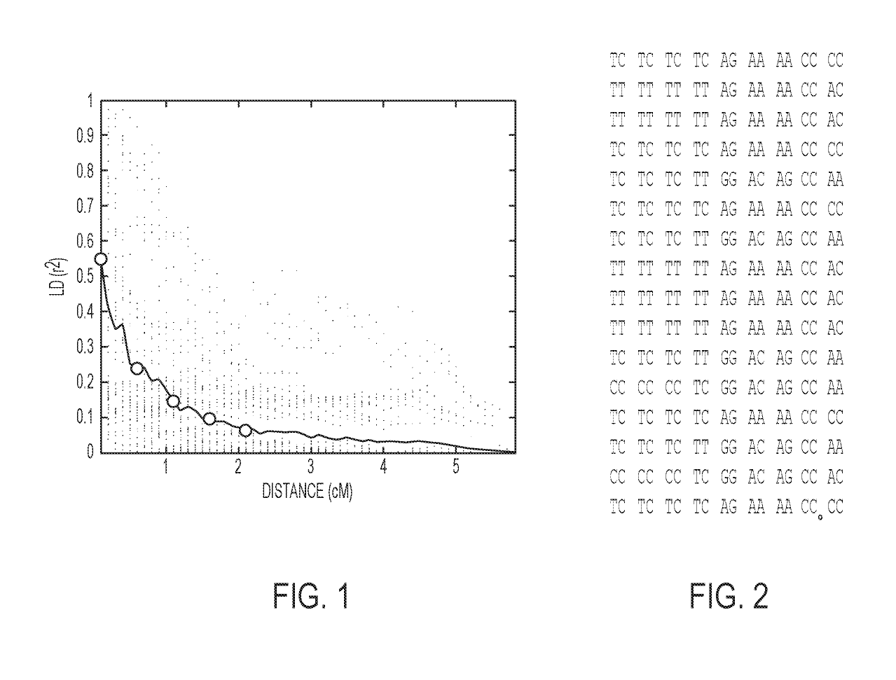

Turning now to the drawings in greater detail, wherein like reference numerals indicate like elements, according to one or more embodiments FIG. 1 depicts a diagram illustrating a distribution used as inputs characteristics, and FIG. 2 depicts an output matrix illustrating an example of a genetic population that satisfies the input characteristics of the distribution shown in FIG. 1. As previously noted, the problem of generating the simulated genetic population model represented by the matrix shown in FIG. 2 may be stated as the problem of generating a population of “N” diploids (or “2N” haploids) with “M” bi-allelic SNPs given the inputs depicted in FIG. 1, which are, namely, a MAFs “p” distribution, and an average LD “r²” distribution per genetic distance. The parameters “p” and “r²” as shown in FIG. 1 are typically derived from an existing population “P”, and the task is to generate a “perturbed” population P′ that substantially matches existing population “P” by showing similar characteristics as existing population “P.” In other words, the task is to “simulate” the genetic population shown by the output matrix in FIG. 2 to substantially match the distribution shown in FIG. 1, which is typically a distribution observed in nature. The simulated output matrix in FIG. 2 includes rows and columns formed from pairs of letters, or pairs of nucleotides. Each row represents a different individual, and each column represents a different marker or position on the genome. If the matrix of data in FIG. 2 matches the distribution in FIG. 1, any statistics computed from the output matrix data should substantially match those observed from real data, such as the input distribution in FIG. 1.

Turning now to an overview of the present disclosure, one or more embodiments provide systems and methodologies for simulating final models of genetic populations directly based on a given LD distribution and without the need to use forward-simulation models and intermediate genetic populations. In accordance with one or more embodiments, target statistics for the simulated population are defined, and a population is generated that directly matches those statistics without forward in time or backward in time simulation, and without sampling from a known population. More specifically, the disclosed systems/methodologies observe the allele frequencies, which are the frequency of each letter at each column. The disclosed systems/methodologies then observe the “pairwise linkage” or LD statistic, which is a biological term that means a determination of whether these pairwise markers have similar patterns across adjacent makers. Having similar patterns across adjacent markers means the markers were inherited together. The LD statistic, which is also referred to as r², is computed across all possible pairs of markers, and the average for each distance is computed. For example, from marker 1 to marker 3, the distance would be 2. LD is computed for all the possible pairs of markers that are a distance 2, and the average is computed, which should match the LD (r²) of the input distribution shown in FIG. 1.

In accordance with one or more embodiments of the present disclosure, the allele frequencies are assigned before the LD is assigned/computed in order to provide more flexibility because the assignment/computation of LD depends on the allele frequencies. This ordering allows the development, for each column and column pair, of the exact allele frequency and LD that matches the input distribution, which allows the output matrix to be generated relatively quickly using linear algebra techniques. Accordingly, one or more embodiments of the present disclosure facilitate the effective incorporation of algebraic methods to solve a combinatorial problem. Thus, the disclosed systems and methodologies directly generate LD at the desired level, and linear algebra techniques are combined and utilized in a unique way to enable the direct simulation of a population P′ having the input characteristics “p” and “r².”

At least the features and combinations of features described in the immediately preceding paragraphs, including the corresponding features and combinations of features depicted in the FIGS., amount to significantly more than implementing a method of simulating final models of genetic populations in a particular technological environment. Additionally, at least the features and combinations of features described in the immediately preceding paragraphs, including the corresponding features and combinations of features depicted in the FIGS., go beyond what is well-understood, routine and conventional in the relevant field(s).

The systems and methodologies of the present disclosure facilitate the incorporation of linear algebraic solution techniques with combinatoric solution techniques to improve the accuracy, speed, efficiency and effectiveness of the overall solution. In general, combinatorics is a branch of mathematics concerning the study of finite or countable discrete structures. Aspects of combinatorics include counting the structures of a given kind and size (enumerative combinatorics), deciding when certain criteria can be met, and constructing and analyzing objects meeting the criteria (as in combinatorial designs and matroid theory), finding “largest”, “smallest”, or “optimal” objects (extremal combinatorics and combinatorial optimization), and studying combinatorial structures arising in an algebraic context, or applying algebraic techniques to combinatorial problems (algebraic combinatorics). Additionally, because the output matrix, generated in accordance with the present disclosure, is simulated data that has similar characteristics to real data, it can be used in a variety of ways. For example, the output matrix could be used to study disease models for human populations, or to make predictions about how a real population may behave under certain conditions, or to improve breeding simulators for plant breeding by providing more accurate initial populations for the simulators.

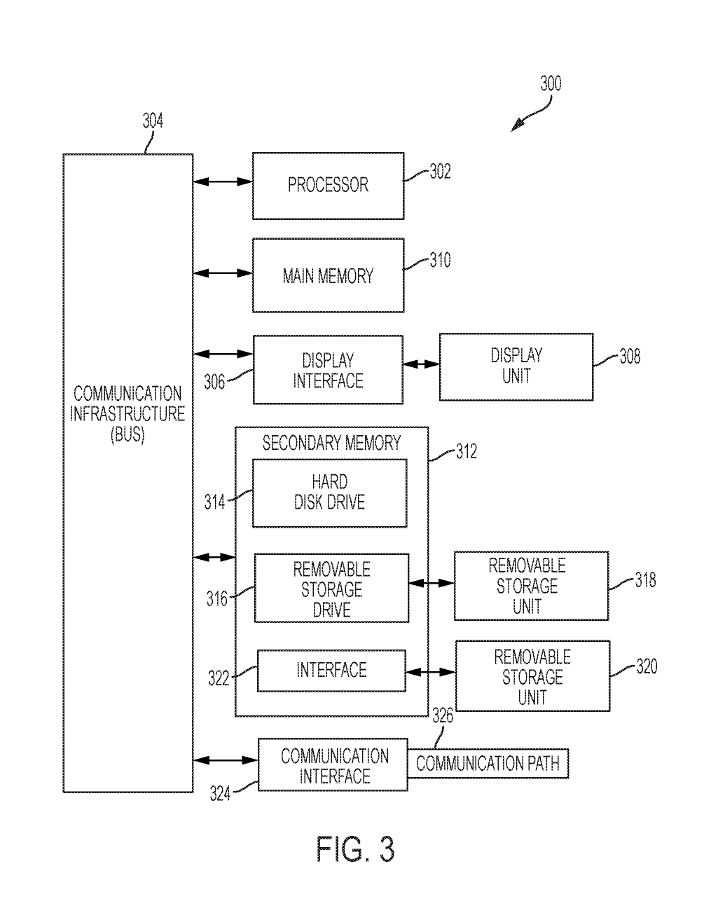

Turning now to a more detailed description of the present disclosure, FIG. 3 illustrates a high level block diagram showing an example of a computer-based simulation system 300 useful for implementing one or more embodiments. Although one exemplary computer system 300 is shown, computer system 300 includes a communication path 326, which connects computer system 300 to additional systems and may include one or more wide area networks (WANs) and/or local area networks (LANs) such as the internet, intranet(s), and/or wireless communication network(s). Computer system 300 and additional system are in communication via communication path 326, e.g., to communicate data between them.

Computer system 300 includes one or more processors, such as processor 302. Processor 302 is connected to a communication infrastructure 304 (e.g., a communications bus, cross-over bar, or network). Computer system 300 can include a display interface 306 that forwards graphics, text, and other data from communication infrastructure 304 (or from a frame buffer not shown) for display on a display unit 308. Computer system 300 also includes a main memory 310, preferably random access memory (RAM), and may also include a secondary memory 312. Secondary memory 312 may include, for example, a hard disk drive 314 and/or a removable storage drive 316, representing, for example, a floppy disk drive, a magnetic tape drive, or an optical disk drive. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disk, etc. which is read by and written to by removable storage drive 316. As will be appreciated, removable storage unit 318 includes a computer readable medium having stored therein computer software and/ or data.

In alternative embodiments, secondary memory 312 may include other similar means for allowing computer programs or other instructions to be loaded into the computer system. Such means may include, for example, a removable storage unit 320 and an interface 322. Examples of such means may include a program package and package interface (such as that found in video game devices), a removable memory chip (such as an EPROM, or PROM) and associated socket, and other removable storage units 320 and interfaces 322 which allow software and data to be transferred from the removable storage unit 320 to computer system 300.

Computer system 300 may also include a communications interface 324. Communications interface 324 allows software and data to be transferred between the computer system and external devices. Examples of communications interface 324 may include a modem, a network interface (such as an Ethernet card), a communications port, or a PCM-CIA slot and card, etcetera. Software and data transferred via communications interface 324 are in the form of signals which may be, for example, electronic, electromagnetic, optical, or other signals capable of being received by communications interface 324. These signals are provided to communications interface 324 via communication path (i.e., channel) 326. Communication path 326 carries signals and may be implemented using wire or cable, fiber optics, a phone line, a cellular phone link, an RF link, and/or other communications channels.

In the present disclosure, the terms “computer program medium,” “computer usable medium,” and “computer readable medium” are used to generally refer to media such as main memory 310 and secondary memory 312, removable storage drive 316, and a hard disk installed in hard disk drive 314. Computer programs (also called computer control logic) are stored in main memory 310 and/or secondary memory 312. Computer programs may also be received via communications interface 324. Such computer programs, when run, enable the computer system to perform the features of the present disclosure as discussed herein. In particular, the computer programs, when run, enable processor 302 to perform the features of the computer system. Accordingly, such computer programs represent controllers of the computer system.

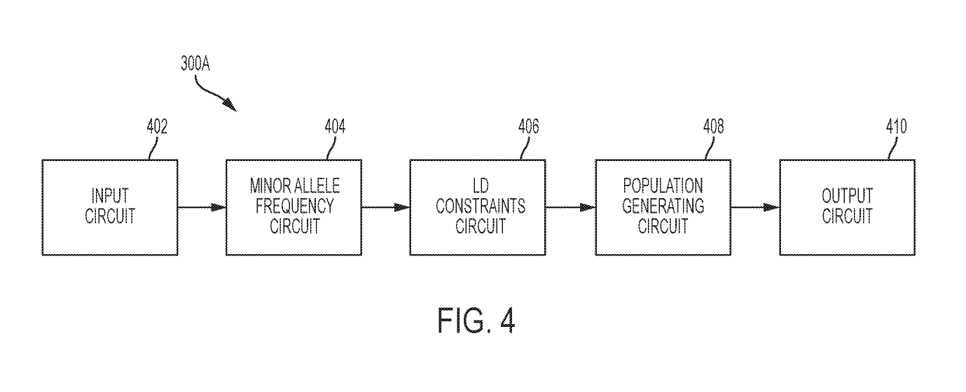

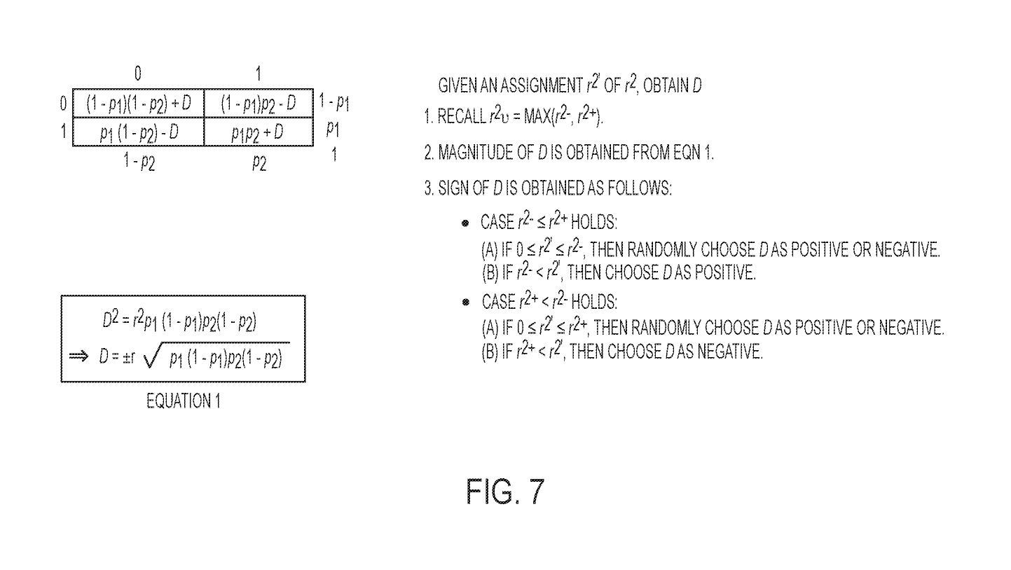

FIG. 4 depicts a diagram illustrating a more detailed implementation of a computer-based simulation system 300A useful in implementing one or more embodiments of the present disclosure. Computer system 300A includes an input circuit 402, a MAF circuit 404, a LD constraints circuit 406, a population generating circuit 408 and an output circuit 410, configured and arranged as shown. In operation, input circuit 402 receives an input distribution of the type shown in FIG. 1. Circuits 404, 406, 408, 410 generate the simulated output matrix (shown in FIG. 2) in accordance with the present disclosure such that the simulated output matrix matches the input distribution (shown in FIG. 1). MAF circuit 404 assigns, for each marker j=M, a MAF pⱼ. LD constraints circuit 406 assigns LD constraints r²_{j,h}, for each marker j and distance h=1, . . . j-1. Population generating circuit 408 generates a population having constraints pⱼ and r²_{j,h}. The functionality of LD constraints circuit 406 and population generating circuit 408 may be implemented by linear algebraic computational techniques, examples of which are illustrated in FIGS. 7 to 12 and described in greater detail later in this disclosure. Because, according to the present disclosure, greater flexibility is provided by assigning the allele frequencies before the LD is assigned/computed, this ordering allows the development, for each column and column pair, of the exact allele frequency and LD that matches the input distribution, which allows the output matrix to be generated relatively quickly using linear algebra techniques. Accordingly, one or more embodiments of the present disclosure facilitate the effective incorporation of algebraic methods to solve a combinatorial problem. Output circuit 410 generates the simulated population matrix in the format shown in FIG. 2 having N diploids at M markers.

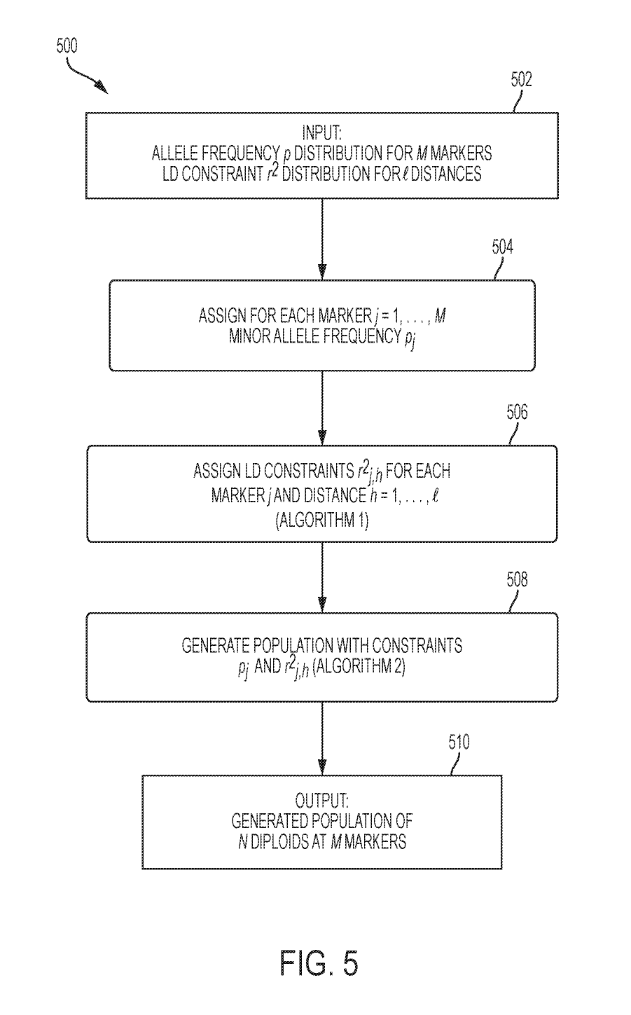

FIG. 5 depicts a flow diagram illustrating an overall methodology 500 for generating a simulated output matrix according to one or more embodiments. Methodology 500 begins at block 502 by receiving an input distribution of the type shown in FIG. 1. Blocks 504,506, 508, 510 generate the simulated output matrix (shown in FIG. 2) in accordance with the present disclosure such that the simulated output matrix matches the input distribution (shown in FIG. 1). Block 504 assigns, for each marker j=1, . . . M, a MAF pⱼ. Block 506 assigns LD constraints r²_{j,h}, for each marker j and distance h=1, . . . j-1. Block 508 generates a population having constraints pⱼ and r²_{j, h}. The functionality of blocks 506, 508, similar to the functionality of LD constraints circuit 406 and population generating circuit 408 (each shown in FIG. 4) may be implemented by linear algebraic computational techniques, examples of which are illustrated in FIGS. 7 to 12 and described in greater detail later in this disclosure. As previously noted herein, because, according to the present disclosure, greater flexibility is provided by assigning the allele frequencies before the LD is assigned/computed, this ordering allows the development, for each column and column pair, of the exact allele frequency and LD that matches the input distribution, which allows the output matrix to be generated relatively quickly using linear algebra techniques. Accordingly, one or more embodiments of the present disclosure facilitate the effective incorporation of algebraic methods to solve a combinatorial problem. Output circuit 410 generates the simulated population matrix in the format shown in FIG. 2 having N diploids at M markers.

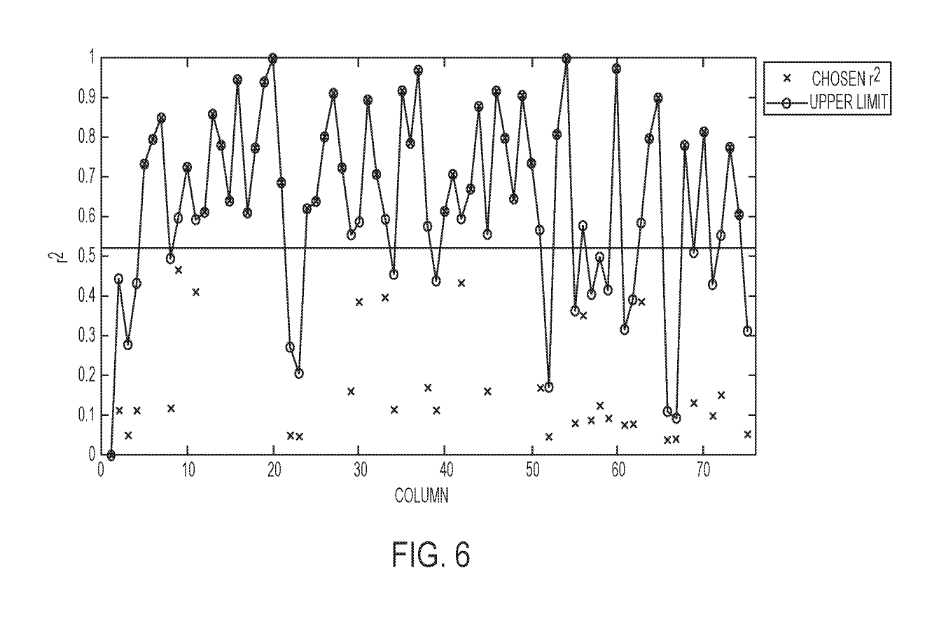

Additional detail of the functionality of circuits 406, 408 (shown in FIG. 4) and blocks 506, 508 (shown in FIG. 5) will now be described with reference to FIGS. 6 to 12. As previously noted herein, according to one or more embodiments markers are assigned as an initial step, which allows known algebraic methods to be used as the algorithm to solve the equations once all the constraints are in place. FIG. 6 depicts a diagram illustrating the limits on LD (i.e., r²) imposed by assigning the MAFs according to system 300A shown in FIG. 4 and methodology 500 shown in FIG. 5. Specifically, FIG. 6 illustrates, for one specific distance at each generated column (SNP), the limits (circles) for r² imposed by the allele frequencies and selected r² values. By assigning MAF in circuit 404 and block 504, upper limits are imposed on the assignment of r² for each column/marker.

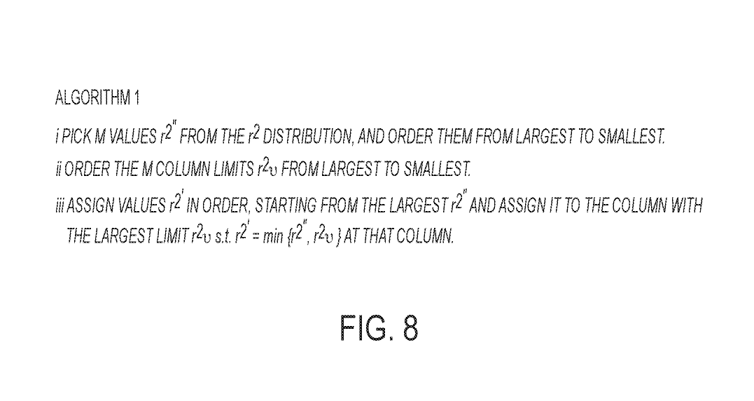

FIG. 7 illustrates a perturbation calculation for determining a distance (D) in implementing circuit LD constraints circuit 406 (shown in FIG. 4) and block 506 (shown in FIG. 5). FIG. 8 illustrates an Algorithm 1 that may be applied in assigning LD constraints in LD constraints circuit 406 and block 506.

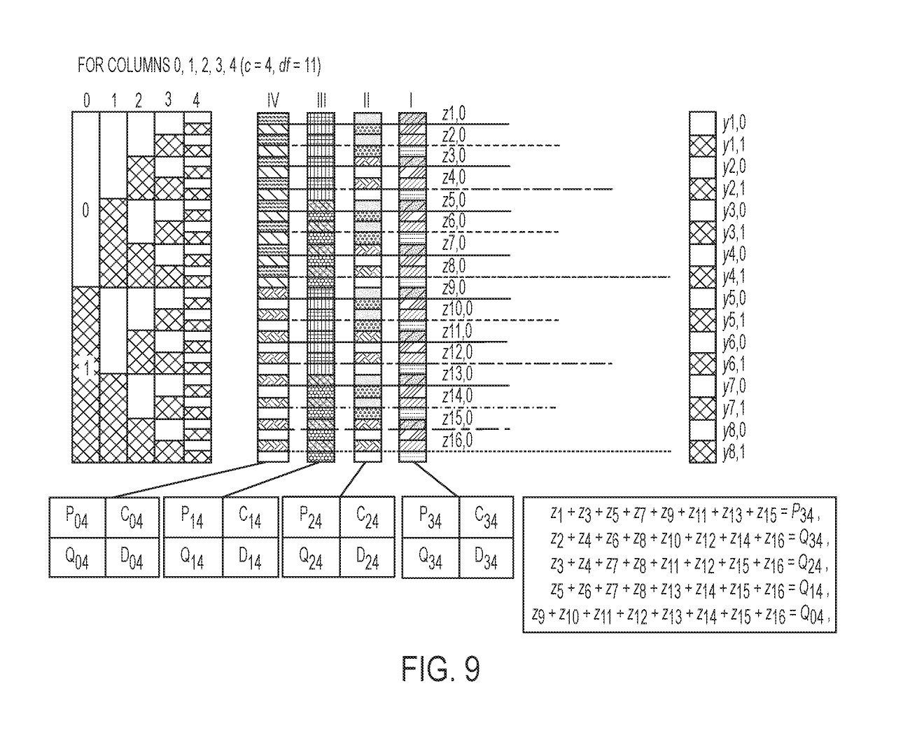

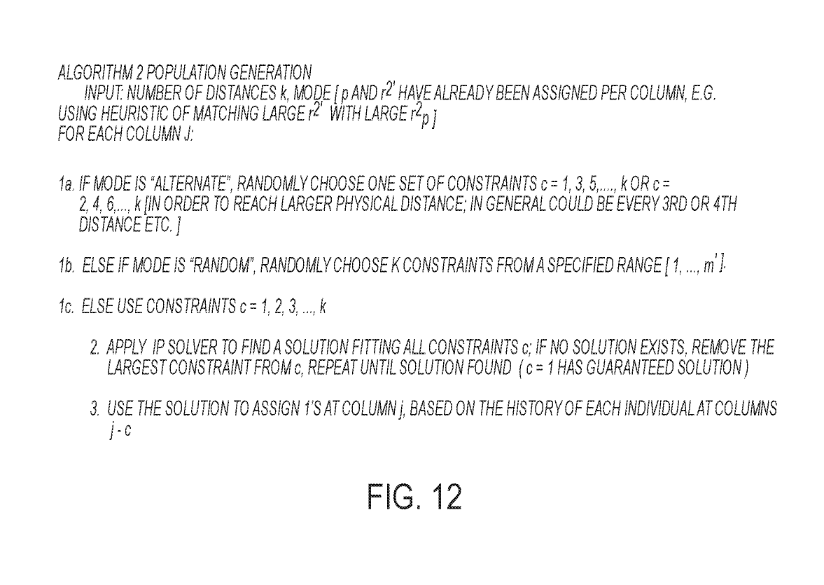

FIG. 9 depicts a combination of combinatoric solution methods and linear algebra solution methods, which may be used in developing an algebraic combinatorial algorithm (e.g., Algorithm 2 shown in FIG. 12) to generate the population. FIG. 9 focuses on columns 0, 1, 2, 3 and 4 (i.e., c=4, and df=11). Because of the disclosed manner in which the constraints are computed, and because of the disclosed manner in which the constraints are assigned, there is wide flexibility in the choice of algorithms to satisfy the constraints. The diagram of FIG. 9 demonstrates the pairwise constraints up to a distance 4, along with how the problem is modeled as the linear algebraic equations shown in the lower right hand corner of FIG. 9. The letters P₃₄, Q₃₄, Q₂₄, Q₁₄ and Q₀₄ are the actual values that are obtained from the r² constraint.

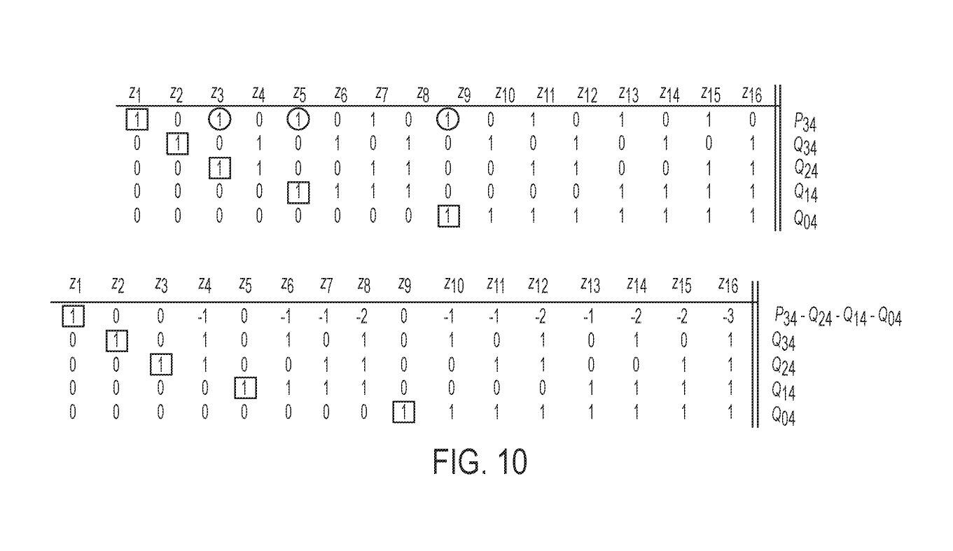

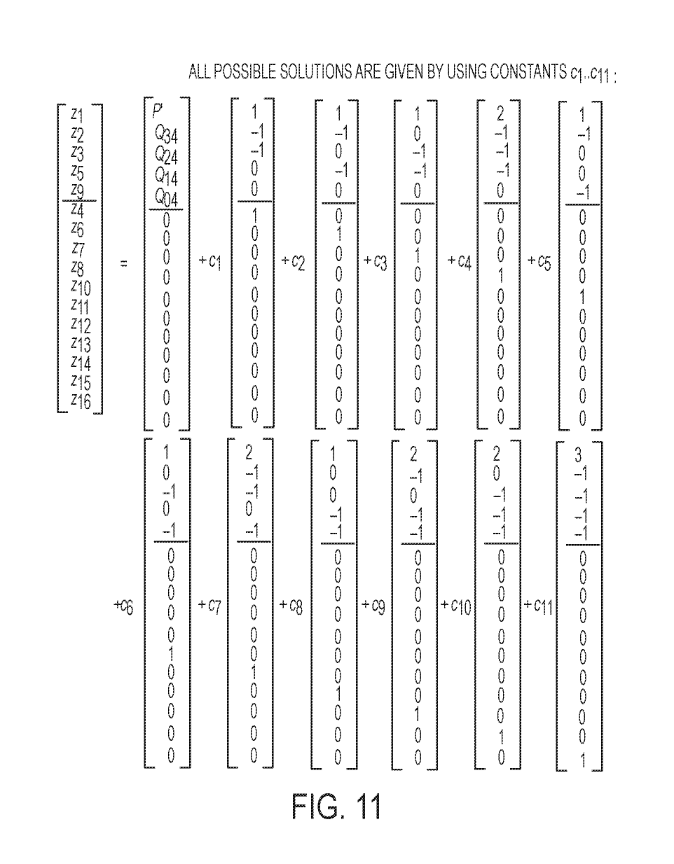

FIG. 10 provides substantially the same the linear algebraic equations of FIG. 9 but in a different format, which is chosen to facilitate the use a standard solver for integer programming (IP) to solve these equations and obtain the elements z₁, z₂, z₃, et seq., which will be the solution to the matrix problem. FIG. 11 provides a more explicit recitation of the equations in FIG. 10.

FIG. 12 depicts an Algorithm 2 that may be applied to generate a population with MAFs constraints and LD constraints according to population generating circuit 408 (shown in FIG. 4) and block 508 (shown in FIG. 5). Operation 1 of Algorithm 2 provides alternative implementation under 1a, 1b and 1c.

Thus, it can be seen from the foregoing description and illustration that one or more embodiments of the present disclosure provide technical features and benefits. Specifically, the present disclosure provides systems and methodologies for simulating final models of genetic populations directly based on a given LD distribution and without the need to use forward-simulation models and intermediate genetic populations. In accordance with one or more embodiments, target statistics for the simulated population are defined, and a population is generated that directly matches those statistics without forward in time or backward in time simulation, and without sampling from a known population.

The systems and methodologies of the present disclosure facilitate the incorporation of linear algebraic solution techniques with combinatoric solution techniques to improve the accuracy, speed, efficiency and effectiveness of the overall solution. In accordance with the present disclosure, the allele frequencies are assigned before the LD is assigned/computed in order to provide more flexibility because the assignment/computation of LD depends on the allele frequencies. This ordering allows the development, for each column and column pair, of the exact allele frequency and LD that matches the input distribution, which allows the output matrix to be generated relatively quickly using linear algebra techniques. Accordingly, one or more embodiments of the present disclosure facilitate the effective incorporation of algebraic methods to solve a combinatorial problem. Thus, the disclosed systems and methodologies directly generate LD at the desired level, and linear algebra techniques are combined and utilized in a unique way to enable the direct simulation of a population P′ having the input characteristics “p” and “r².” Because the output matrix, generated in accordance with the present disclosure, is simulated data that has similar characteristics to real data, it can be used in a variety of ways. For example, the output matrix could be used to study disease models for human populations, or to make predictions about how a real population may behave under certain conditions.

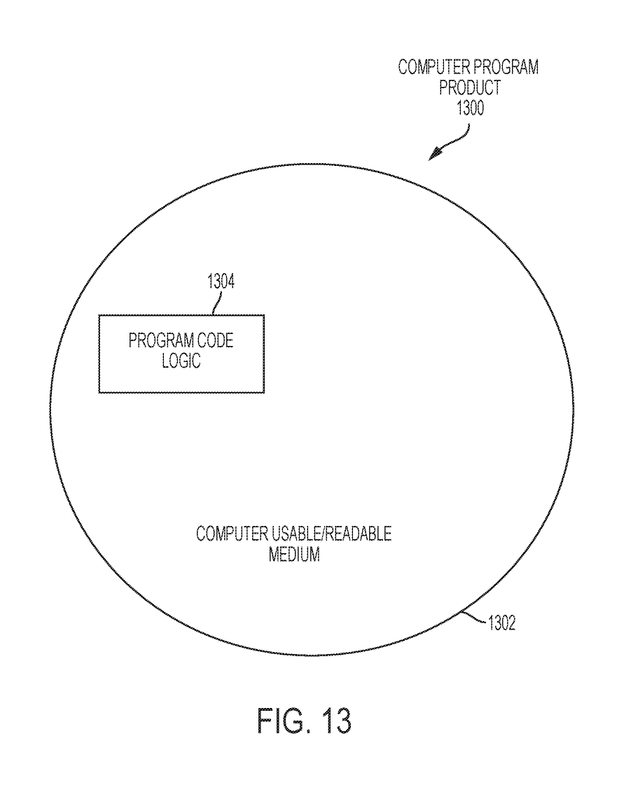

Referring now to FIG. 13, a computer program product 1300 in accordance with an embodiment that includes a computer readable storage medium 1302 and program instructions 1304 is generally shown.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

It will be understood that those skilled in the art, both now and in the future, may make various improvements and enhancements which fall within the scope of the claims which follow.

What is claimed is:

1. The method of claim 1 further comprising:
using the processor system to constrain each marker of the simulated population matrix based at least in part on the minor allele frequency of the marker and the LD of the marker;
wherein the simulated population matrix substantially matches the input distribution.

2. The method of claim 1, wherein the processor system uses an algebraic combinatorial algorithm to generate and output the simulated population matrix.

3. The method of claim 2, wherein the algebraic combinatorial algorithm comprises an integer programming solver.

4. The method of claim 2, wherein:
the simulated population matrix comprises rows and columns;
each of the rows identifies an individual; and
each of the columns represents a specific marker on a genome.

5. The method of claim 4, wherein the specific marker comprises a pair of nucleotides.

6. The method of claim 1, wherein the assignment of the minor allele frequency for each marker of the simulated population matrix imposes a limit on the assignment of the LD for each marker and each distance of the simulated population matrix.
